(19) United States
(12) Patent Application Publication
(10) Pub. No.: US 2026/0109188 A1
(43) Pub. Date: Apr. 23, 2026

(54) BIONIC JUMPING AND FLYING ROBOT BASED ON JUMPING-FLAPPING WING COMPOSITE STRUCTURE

(71) Applicant: Beijing Institute of Technology, Beijing (CN)

(72) Inventors: Qing SHI, Beijing (CN); Yi XU, Beijing (CN); Yishi SHEN, Beijing (CN); Liang PENG, Beijing (CN); Zhiyuan WU, Beijing (CN); Qi LI, Beijing (CN)

(21) Appl. No.: 19/022,073

(22) Filed: Jan. 15, 2025

(30) Foreign Application Priority Data
Oct. 23, 2024 (CN) 202411479715.X

(51) Int. Cl. B60F 5/02; B62D 57/02; B64C 33/02

(52) U.S. Cl. CPC B60F 5/02; B62D 57/02; B64C 33/02

(57) ABSTRACT

Provided is a bionic jumping and flying robot based on a jumping-flapping wing composite structure including a leg-foot type jumping module, a counterbeat flight module, a driving body and a tail wing module. The leg-foot type jumping module is connected to the driving body and configured for completing a jumping function. The counterbeat flight module is connected to the driving body and configured for providing flight lift and thrust. The tail wing module is connected to the driving body, and an installation angle of the tail wing module is adjustable.

### CROSS-REFERENCE TO RELATED APPLICATION

This patent application claims the benefit and priority of Chinese Patent Application No. 202411479715.X filed with the China National Intellectual Property Administration on Oct. 23, 2024, the disclosure of which is incorporated by reference herein in its entirety as part of the present application.

### TECHNICAL FIELD

The present disclosure relates to the technical field of bionic robots, in particular to a bionic jumping and flying robot based on a jumping-flapping wing composite structure.

### BACKGROUND

The micro land-air amphibious robot with insects as bionic objects has the advantages of flexibility, small size and high concealment, realizing extremely high adaptability to complex environments, and shows good application prospects in unmanned reconnaissance, post-disaster rescue, narrow space inspection and other fields. However, the existing bionic land-air robot is low in structural adaptability, and is formed with combined simple structures, which is difficult to realize efficient driving with high energy density, high integration level, and high explosion in a small scale. And, the existing bionic land-air robot has a low movement coupling degree, and does not explore the complementary advantages of movements in multiple modes, causing that an efficient composite movement whole assembly may not be formed.

### SUMMARY

The present disclosure aims to provide a bionic jumping and flying robot based on a jumping-flapping wing composite structure so as to solve the problems in the prior art and realize high drive ratio and high coupling degree.

In order to achieve the above-mentioned purpose, the present disclosure provides the following scheme.

The present disclosure provides a bionic jumping and flying robot based on a jumping-flapping wing composite structure. The bionic jumping and flying robot based on a jumping-flapping wing composite structure includes a leg-foot type jumping module, a counterbeat flight module, a driving body and a tail wing module. The leg-foot type jumping module is connected to the driving body and configured for completing a jumping function; the counterbeat flight module is connected to the driving body and configured for providing flight lift and thrust; and the tail wing module is connected to the driving body, and an installation angle of the tail wing module is adjustable.

Preferably, the leg-foot type jumping module includes a plurality of supporting legs, an action element and two jumping units. The two jumping units are symmetrically arranged on two sides of the driving body, the two jumping units are both connected to the driving body, the driving body is capable of driving the two jumping units to jump synchronously, and the plurality of supporting legs are installed on the driving body for supporting on a ground.

Preferably, the two jumping units are identical in structures, each of the two jumping units comprises a leg side plate, a thigh connecting rod, a tibia connecting rod, and a dactylus, one end of the leg side plate is connected to the driving body, an other end of the leg side plate is hinged to one end of the thigh connecting rod, an other end of the thigh connecting rod is hinged to an upper end of the tibia connecting rod, the action element is connected to a first output end of the driving body, the driving body is capable of driving the action element to move, so that the action element drives the tibia connecting rod to rotate realize jumping, a lower end of the tibia connecting rod is hinged to the dactylus, and burrs are arranged on one side, used for gripping on the ground, of the dactylus.

Preferably, in of the two jumping units, the thigh connecting rod includes two thigh connecting rods, the tibia connecting rod includes one tibia connecting rod, the two thigh connecting rods are located on two sides of the tibia connecting rod, and the tibia connecting rod is hinged to the two thigh connecting rods.

Preferably, the action element includes a reel, a D-shaped shaft, a trigger sliding rod and an elastic energy storage element, the trigger sliding rod passes through a strip hole formed in each of the two thigh connecting rods, two ends of the trigger sliding rod are limited at thigh connecting rods on two sides of the trigger sliding rod, the D-shaped shaft passes through two leg side plates, one end of the D-shaped shaft is connected to the first output end of the driving body, the reel is connected to the D-shaped shaft, the reel includes two reels, the two reels are in one-to-one correspondence with two tibia connecting rods, each of the two reels is wound with two ropes, and ends of the two ropes are respectively connected to a thread hole in a corresponding tibia connecting rod and the trigger sliding rod; a same limit connecting rod penetrates through upper ends of the two tibia connecting rods, the elastic energy storage element includes two elastic energy storage elements, the two elastic energy storage elements are in one-to-one correspondence with two groups of thigh connecting rods, one end of each of the two elastic energy storage elements is connected to an upper end of a middle part of each of the two thigh connecting rods, and an other end of the each of the elastic energy storage elements is connected to the limit connecting rod; when the driving body drives the D-shaped shaft to drive the two reels to rotate forward, one of the two ropes that is connected to the tibia connecting rod pulls the tibia connecting rod to rotate and fold towards the thigh connecting rods until an overhead hook on the upper end of the tibia connecting rod is clamped onto an upper end of the trigger sliding rod, while the two elastic energy storage elements are in an extension state; when the driving body drives the D-shaped shaft to drive the two reels to rotate backward, an other, connecting to the trigger sliding rod, of the two rope pulls the trigger sliding rod to move towards the leg side plate along the strip hole, the trigger sliding rod is separated from the overhead hook on the upper end of the tibia connecting rod, while the two elastic energy storage elements contract and drive the tibia connecting rod to rotate away from the two thigh connecting rods until the two elastic energy storage elements completely reset.

Preferably, the counterbeat flight module includes a flight frame, a reduction gear set, two swing arms, two swing arm bases and two flapping wing units, the flight frame is connected to the driving body, the two flapping wing units are symmetrically installed on the flight frame, the reduction gear set is installed on the flight frame, an input end of the reduction gear set is connected to a second output end of the driving body, the two swing arm bases are installed on the flight frame through a shaft, the two swing arms, the two flapping wing units and the two swing arm bases are in one-to-one correspondence, one end of each of the two swing arms is hinged to a corresponding one of the two swing arm bases, each of the swing arm bases is connected to a corresponding one of the two flapping wing units, and an other end of each of the two swing arms is hinged to a corresponding one of two output ends of the reduction gear set.

Preferably, the reduction gear set includes a primary double-layer reduction gear and two secondary reduction gears, the primary double-layer reduction gear includes a primary large gear and a primary small gear, a periphery of the primary large gear is engaged with an output small gear of the driving body, the primary small gear is coaxially connected onto one side of the primary large gear, a periphery of the primary small gear is engaged with the two secondary reduction gears, the two secondary reduction gears are in one-to-one correspondence with the two swing arms, and the other end of each of the two swing arms is eccentrically hinged to one side of a corresponding one of the two secondary reduction gear.

Preferably, each of the two flapping wing units includes a flapping wing skeleton and a flapping wing membrane, a root of the flapping wing skeleton is inserted into a corresponding one of the two swing arm bases, and a front end of the flapping wing membrane is pasted onto the flapping wing skeleton.

Preferably, the driving body includes a flight driving motor, a rear-end limit frame, fuselage side plates, a jumping driving motor, a front-end limit frame, a worm and a worm wheel, a groove is formed in the front-end limit frame, the flight frame of the counterbeat flight module is installed in the groove, the fuselage side plates are connected to leg side plates of the leg-foot type jumping module, the rear-end limit frame is located between the fuselage side plates and inserted in installation holes of the fuselage side plates, the flight driving motor is installed on the flight frame, the flight driving motor is connected with an output small gear configured for connecting an input end of the counterbeat flight module, the jumping driving motor is installed between the front-end limit frame and the rear-end limit frame, the jumping driving motor is connected to the worm, the worm is matched and connected with the worm wheel, and the worm wheel is connected to the D-shaped shaft of the leg-foot type jumping module.

Preferably, the tail wing module includes a tail wing base, a tail wing skeleton and a tail wing membrane, the tail wing base is installed on the fuselage side plates of the driving body, a root of the tail wing skeleton is inserted into the tail wing base, and the tail wing membrane is pasted onto the tail wing skeleton.

Compared with the prior art, the present disclosure has the following technical effects:

In the bionic jumping and flying robot based on a jumping-flapping wing composite structure provided by the present disclosure, the leg-foot type jumping module is connected to the driving body, and configured for completing a jumping function and the counterbeat flight module is connected to the driving body, and configured for providing flight lift and thrust. The leg-foot type jumping module and the counterbeat flight module are respectively driven by the driving body, realizing composition of jumping and flight and having characteristics of high drive ratio and high coupling degree. The tail wing module is connected to the driving body, and the installation angle of the tail wing module is adjustable, so that the magnitude of pitching moment is adjusted to realize control for flight attitude, improving the adaptability.

### BRIEF DESCRIPTION OF THE DRAWINGS

To describe the technical solutions of the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a structural schematic diagram of a bionic jumping and flying robot based on a jumping-flapping wing composite structure in the present disclosure;

FIG. 2 is a structural schematic diagram of a leg-foot type jumping module in the present disclosure.

FIG. 3 is a structural schematic diagram of a counterbeat flight module in the present disclosure.

FIG. 4 is a structural schematic diagram of a driving body in the present disclosure.

FIG. 5 is a structural schematic diagram of a tail wing module in the present disclosure.

Reference signs: 1, leg-foot type jumping module; 101, leg side plate; 102, thigh connecting rod; 103, tibia connecting rod; 104, dactylus; 105, reel; 106, trigger sliding rod; 107, elastic energy storage element; 108, supporting leg; 109, overhead hook; 2, counterbeat flight module; 201, flight frame; 202, primary large gear; 203, secondary reduction gear; 204, swing arm; 205, swing arm base; 206, flapping wing skeleton; 207, flapping wing membrane; 208, primary small gear; 3, driving body; 301, flight driving motor; 302, front-end limit frame; 303, fuselage side plate; 304, jumping driving motor; 305, rear-end limit frame; 306, worm; 307, worm wheel; 308, D-shaped shaft; 4, tail wing module; 401, tail wing base; 402, tail wing skeleton; and 403, tail wing membrane.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

The present disclosure aims to provide a bionic jumping and flying robot based on a jumping-flapping wing composite structure so as to solve the problems in the prior art and realize high drive ratio and high coupling degree.

To make the foregoing objective, features and advantages of the present disclosure clearer and more comprehensible, the present disclosure is further described in detail below with reference to the attached figures and specific embodiments.

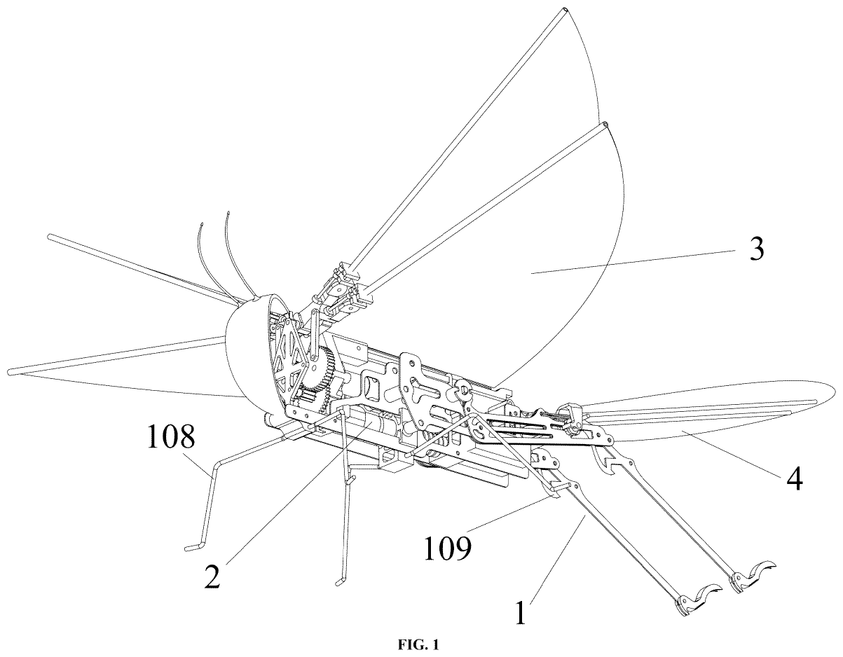

As shown in FIG. 1 to FIG. 5, the embodiment provides a bionic jumping and flying robot based on a jumping-flapping wing composite structure including a leg-foot type jumping module 1, a counterbeat flight module 2, a driving body 3 and a tail wing module 4. The leg-foot type jumping module 1 is connected to the driving body 3, and configured for completing a jumping function. The counterbeat flight module 2 is connected to the driving body 3, and configured for providing flight lift and thrust. The leg-foot type jumping module 1 and the counterbeat flight module 2 are driven by the driving body 3, realizing composition of jumping and flight and having the characteristics of high drive ratio and high coupling degree. The tail wing module 4 is connected to the driving body 3, and the installation angle of the tail wing module 4 is adjustable, so that the magnitude of pitching moment is adjusted to realize control for flight attitude, improving the adaptability.

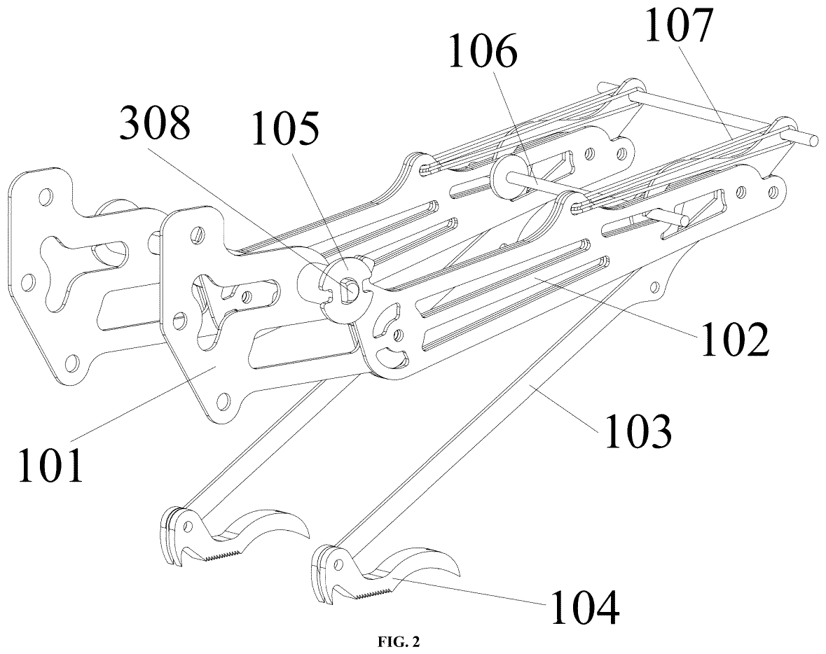

Specifically, as shown in FIG. 2, the leg-foot type jumping module 1 includes multiple supporting legs 108, an action element and two jumping units. The two jumping units are symmetrically arranged on both sides of the driving body 3, and the two jumping units are both connected to the driving body 3. The driving body 3 may drive the two jumping units to jump synchronously, so that jumping is realized by means of the two jumping units, improving the movement stability. The multiple supporting legs 108 are installed on the driving body 3 for supporting on the ground. The number of the supporting legs 108 is preferably four. The supporting legs are respectively installed at the front and middle parts of the whole bionic jumping and flying robot based on a jumping-flapping wing composite structure in pairs. The two jumping units and the action element are installed on the rear part of the whole bionic jumping and flying robot based on a jumping-flapping wing composite structure.

The two jumping units are identical in structures, and each of the jumping units includes a leg side plate 101, thigh connecting rods 102, a tibia connecting rod 103, and a dactylus 104. One end of the leg side plate 101 is connected to the driving body 3, the other end of the leg side plate 101 is hinged to one end of each of the thigh connecting rods 102, and the other end of each of the thigh connecting rods 102 is hinged to an upper end of the tibia connecting rod 103. The action element is connected to a first output end of the driving body 3, and the driving body 3 may drive the action element to move, so that the action element drives the tibia connecting rod 103 to rotate to realize jumping. A lower end of the tibia connecting rod 103 is hinged to the dactylus 104. Burrs are arranged on one side, used for gripping on the ground, of the dactylus 104. During stretching of the tibia connecting rod 103, the dactylus 104 always fits to the ground, and enough gripping force is improved through the burrs.

In each jumping unit, the number of the thigh connecting rods 102 is two, the number of the tibia connecting rods 103 is one, and the thigh connecting rods 102 are located on both sides of the tibia connecting rod 103. The tibia connecting rod 103 is hinged to the two thigh connecting rods 102, facilitating realizing the stretching action of the tibia connecting rod 103.

The action element includes reels 105, a D-shaped shaft 308, a trigger sliding rod 106 and elastic energy storage elements 107. The trigger sliding rod 106 passes through a strip hole formed in each thigh connecting rod 102. The strip hole extends in the length direction of the thigh connecting rod 102. Both ends of the trigger sliding rod 106 are limited at the thigh connecting rods 102 on both sides of the trigger sliding rod 106. As a preferred embodiment, two limit disc plates are arranged on the trigger sliding rod 106, and the two limit disc plates are close to the inner sides of the two thigh connecting rods 102, so that the trigger sliding rod 106 may be prevented from moving in the length direction of the trigger sliding rod 106. The D-shaped shaft 308 passes through the two leg side plates 101, and one end of the D-shaped shaft 308 is connected to the first output end of the driving body 3 and may be driven to rotate by the driving body 3. The reels 105 are connected to the D-shaped shaft 308. The number of the reels 105 is two, and the two reels 105 are in one-to-one correspondence with the two tibia connecting rods 103. The two reels 105 are located on outer end faces of the two leg side plates 101. Each reel 105 is wound with two ropes. Ends of the two ropes are respectively connected to a thread hole in the corresponding tibia connecting rod 103 and the trigger sliding rod 106, so that the two tibia connecting rods 103 may be driven to move by the two reels 105. The two reels 105 are connected to the same D-shaped shaft 308, so that synchronous movement of the two tibia connecting rods 103 may be realized. The trigger sliding rod 106 is also connected with the ropes, so that the movement of the trigger sliding rod 106 may be controlled by the reels 105. As a preferred embodiment, ends of the two ropes on the same reel 105 are fixed with the reel 105, thus respectively performing the operations of leg force storage and leg triggering. The rope for leg force storage is connected from one side of the reel 105 through the thread hole in the rear end of the tibia connecting rod 103 to the other side of the reel 105. The rope for leg triggering is connected to the trigger sliding rod 106. Different strokes of each rope may be coupled through different radii of the reel 105 to respectively realize force storage and triggering. A same limit connecting rod penetrates through upper ends of the two tibia connecting rods 103. The number of the elastic energy storage elements 107 is two, and the two elastic energy storage elements 107 are in one-to-one correspondence with the two sets of thigh connecting rods 102 of the two jumping units. The elastic energy storage element 107 is an elastic string. One end of the elastic energy storage element 107 is connected to an upper end of the middle part of each of the corresponding one set of the thigh connecting rods 102, and the other end of the elastic energy storage element 107 is connected to the limit connecting rod, so that the two elastic energy storage elements 107 are respectively driven to move by the rotation of the two tibia connecting rods 103 while the two elastic energy storage elements 107 also move synchronously since the arrangement of the limit connecting rod. When the driving body 3 drives the D-shaped shaft 308 to rotate the reels 105 forward, the reels 105 drive the ropes to pull the tibia connecting rods 103 to rotate and fold towards the thigh connecting rods 102 until overhead hooks 109 on the upper ends of the tibia connecting rods 103 are clamped onto an upper end of the trigger sliding rod 106 to realize mutual limit of the overhead hooks 109 and the trigger sliding rod 106. At this time, each tibia connecting rod 103 is in a locking state. In this process, the upper ends of the tibia connecting rods 103 drive the elastic energy storage elements 107 to extend. At this time, each elastic energy storage element 107 is in an extension state to realize energy storage. When stretching is needed, the driving body 3 drives the D-shaped shaft 308 to rotate the reels 105 backward, and the reels 105 drive the ropes to pull the trigger sliding rod 106 to move towards the leg side plates 101 along the strip hole, that is, towards the openings of the overhead hooks 109 until the trigger sliding rod 106 is separated from the overhead hooks 109. At this time, the limit between the trigger sliding rod 106 and the overhead hooks 109 disappears. Under the action of elastic restoring forces of the elastic energy storage elements 107, the elastic energy storage elements 107 contract and drive the tibia connecting rods 103 to rotate away from the thigh connecting rods 102 until the elastic energy storage elements 107 completely reset. That is, the tibia connecting rods 103 quickly rotate away from the thigh connecting rods 102 to realize a stretching action, completing jumping.

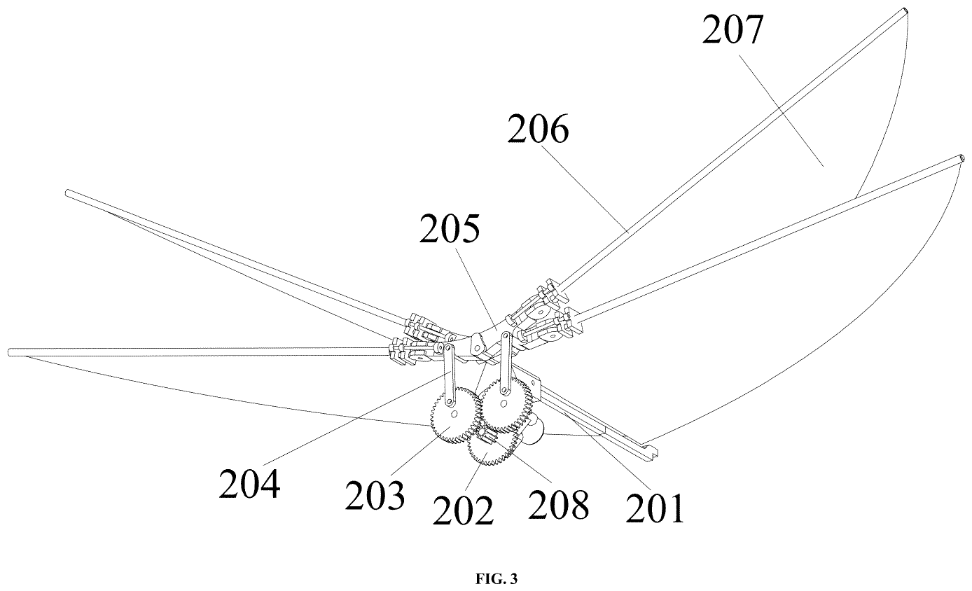

As shown in FIG. 3, the counterbeat flight module 2 includes a flight frame 201, a reduction gear set, two swing arms 204, two swing arm bases 205 and two flapping wing units. The flight frame 201 is connected to a flight driving motor 301 in the driving body 3. The two flapping wing units are symmetrically installed on the flight frame 201. The reduction gear set is installed on the flight frame 201, and an input end of the reduction gear set is connected to a second output end of the driving body 3. The swing arm bases 205 are installed on the flight frame 201 through a shaft. The two swing arms 204, the two flapping wing units and the two swing arm bases 205 are in one-to-one correspondence. One end of the swing arm 204 is hinged to the swing arm base 205. The swing arm base 205 is connected to the flapping wing unit, and the other ends of the two swing arms 204 are respectively hinged to two output ends of the reduction gear set, facilitating realizing the control for the two swing arms 204.

The reduction gear set includes a primary double-layer reduction gear and two secondary reduction gears 203. The primary double-layer reduction gear includes a primary large gear 202 and a primary small gear 208. The periphery of the primary large gear 202 is engaged with an output small gear of the driving body 3. The primary small gear 208 is coaxially connected onto one side of the primary large gear 202. The periphery of the primary small gear 208 is engaged with the two secondary reduction gears 203. When the driving body 3 drives the output small gear to rotate, the output small gear drives the primary large gear 202 to rotate, the primary large gear 202 drives the coaxially connected primary small gear 208 to rotate, and the primary small gear 208 drives the two secondary reduction gears 203 to rotate synchronously. The two secondary reduction gears 203 are in one-to-one correspondence with the two swing arms 204, and one end of the swing arm 204 is eccentrically hinged to one side of the secondary reduction gear 203 to form a crank and rocker mechanism, so that the flapping of each flapping wing unit is realized. The vibration frequency of each flapping unit may be adjusted through the cooperation of the primary double-layer reduction gear and the secondary reduction gears 203.

The flapping wing unit includes a flapping wing skeleton 206 and a flapping wing membrane 207. The root of the flapping wing skeleton 206 is inserted into the swing arm base 205, and a front end of the flapping wing membrane 207 is pasted onto the flapping wing skeleton 206. The flapping wing membrane 207 realizes torsional deformation under the swing of the flapping wing skeleton 206, providing lift and thrust for the bionic jumping and flying robot based on a jumping-flapping wing composite structure.

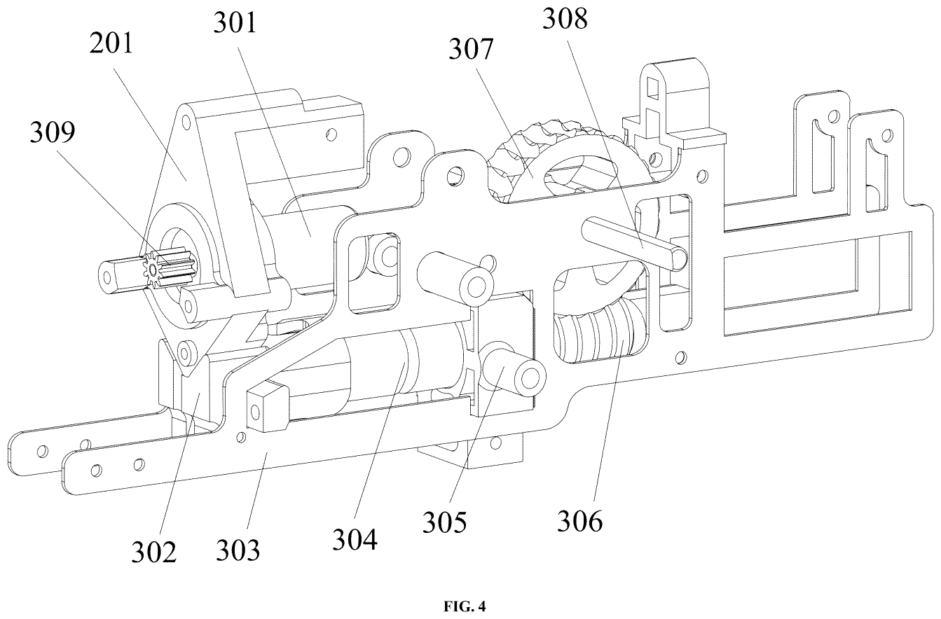

As shown in FIG. 4, the driving body 3 includes a flight driving motor 301, a front-end limit frame 302, fuselage side plates 303, a jumping driving motor 304, a rear-end limit frame 305, a worm 306 and a worm wheel 307. A groove is formed in the front-end limit frame 302. The flight frame 201 of the counterbeat flight module 2 is installed in the groove. The fuselage side plates 303 are connected to the leg side plates 101 of the leg-foot type jumping module 1. The rear-end limit frame 305 is located between the two fuselage side plates 303 and inserted in installation holes of the fuselage side plates 303. The flight driving motor 301 is installed on the flight frame 201, and the flight driving motor 301 is connected with an output small gear configured for connecting an input end of the counterbeat flight module 2 and outputting power for the counterbeat flight module 2. The jumping driving motor 304 is installed between the rear-end limit frame 305 and the front-end limit frame 302. The jumping driving motor 304 is connected to the worm 306. The worm 306 is matched and connected with the worm wheel 307. The worm wheel 307 is connected to the D-shaped shaft 308 of the leg-foot type jumping module 1, so that the worm 306 is driven to rotate by the jumping driving motor 304, the worm 306 drives the worm wheel 307 to rotate, the worm wheel 307 drives the D-shaped shaft 308 to rotate, and finally driving force is output to the leg-foot type jumping module 1. Through the above-mentioned design, the movement coupling degree of the bionic jumping and flying robot based on a jumping-flapping wing composite structure may be improved.

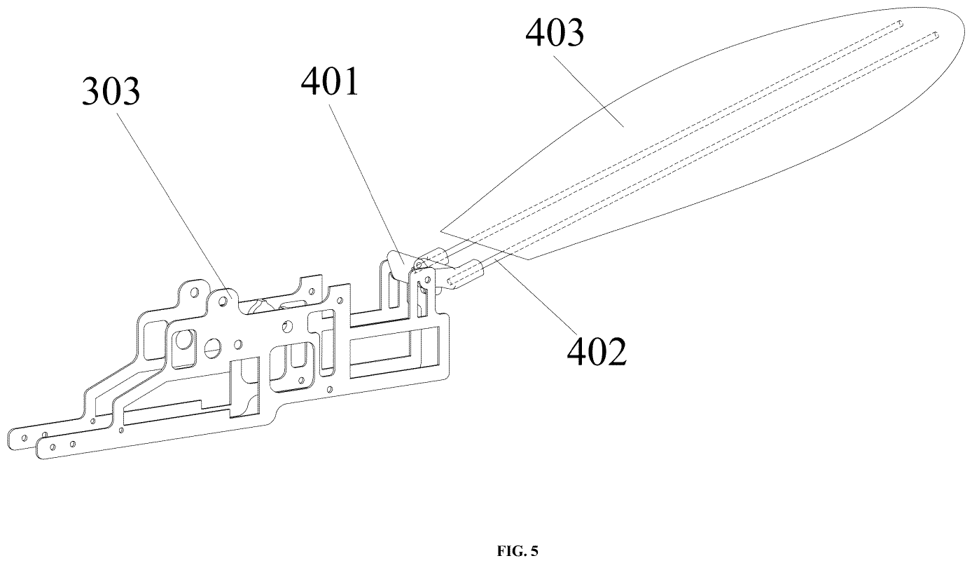

As shown in FIG. 5, the tail wing module 4 includes a tail wing base 401, a tail wing skeleton 402 and a tail wing membrane 403. The tail wing base 401 is installed on the fuselage side plates 303 of the driving body 3. The root of the tail wing skeleton 402 is inserted into the tail wing base 401. Through the angle biasing of the tail wing base 401, the installation angle of the tail wing skeleton 402 is adjusted to adjust the magnitude of pitching moment, improving the adaptability of the bionic jumping and flying robot based on a jumping-flapping wing composite structure. The tail wing membrane 403 is pasted onto the tail wing skeleton 402. The pitching moment is formed through the interaction of the tail wing membrane 403 and air, so that the balance during flight is ensured.

Specific examples are used for illustration of the principles and implementation methods of the present disclosure. The description of the above-mentioned embodiments is used to help illustrate the method and its core principles of the present disclosure. In addition, those skilled in the art can make various modifications in terms of specific embodiments and scope of application in accordance with the teachings of the present disclosure. In summary, the contents of this specification should not be understood as the limitation of the present disclosure.

What is claimed is:

1. A bionic jumping and flying robot based on a jumping-flapping wing composite structure, comprising a leg-foot type jumping module, a counterbeat flight module, a driving body and a tail wing module, wherein the leg-foot type jumping module is connected to the driving body and configured for completing a jumping function; the counterbeat flight module is connected to the driving body and configured for providing flight lift and thrust; and the tail wing module is connected to the driving body, and an installation angle of the tail wing module is adjustable.

2. The bionic jumping and flying robot based on a jumping-flapping wing composite structure according to claim 1, wherein the leg-foot type jumping module comprises a plurality of supporting legs, an action element and two jumping units, the two jumping units are symmetrically arranged on two sides of the driving body, the two jumping units are both connected to the driving body, the driving body is capable of driving the two jumping units to jump synchronously, and the plurality of supporting legs are installed on the driving body for supporting on a ground.

3. The bionic jumping and flying robot based on a jumping-flapping wing composite structure according to claim 2, wherein the two jumping units are identical in structures, each of the two jumping units comprises a leg side plate, a thigh connecting rod, a tibia connecting rod, and a dactylus, one end of the leg side plate is connected to the driving body, an other end of the leg side plate is hinged to one end of the thigh connecting rod, an other end of the thigh connecting rod is hinged to an upper end of the tibia connecting rod, the action element is connected to a first output end of the driving body, the driving body is capable of driving the action element to move, so that the action element drives the tibia connecting rod to rotate realize jumping, a lower end of the tibia connecting rod is hinged to the dactylus, and burrs are arranged on one side, used for gripping on the ground, of the dactylus.

4. The bionic jumping and flying robot based on a jumping-flapping wing composite structure according to claim 3, wherein in each of the two jumping units, the thigh connecting rod comprises two thigh connecting rods, the tibia connecting rod comprises one tibia connecting rod, the two thigh connecting rods are located on two sides of the tibia connecting rod, and the tibia connecting rod is hinged to the two thigh connecting rods.

5. The bionic jumping and flying robot based on a jumping-flapping wing composite structure according to claim 3, wherein the action element comprises a reel, a D-shaped shaft, a trigger sliding rod and an elastic energy storage element, the trigger sliding rod passes through a strip hole formed in each of the two thigh connecting rods, two ends of the trigger sliding rod are limited at thigh connecting rods on two sides of the trigger sliding rod, the D-shaped shaft passes through two leg side plates, one end of the D-shaped shaft is connected to the first output end of the driving body, the reel is connected to the D-shaped shaft, the reel comprises two reels, the two reels are in one-to-one correspondence with two tibia connecting rods, each of the two reels is wound with two ropes, and ends of the two ropes are respectively connected to a thread hole in a corresponding tibia connecting rod and the trigger sliding rod; a same limit connecting rod penetrates through upper ends of the two tibia connecting rods, the elastic energy storage element comprises two elastic energy storage elements, the two elastic energy storage elements are in one-to-one correspondence with two groups of thigh connecting rods, one end of each of the two elastic energy storage elements is connected to an upper end of a middle part of each of the two thigh connecting rods, and an other end of the each of the elastic energy storage elements is connected to the limit connecting rod; when the driving body drives the D-shaped shaft to drive the two reels to rotate forward, one of the two ropes that is connected to the tibia connecting rod pulls the tibia connecting rod to rotate and fold towards the thigh connecting rods until an overhead hook on the upper end of the tibia connecting rod is clamped onto an upper end of the trigger sliding rod, while the two elastic energy storage elements are in an extension state; when the driving body drives the D-shaped shaft to drive the two reels to rotate backward, an other, connecting to the trigger sliding rod, of the two rope pulls the trigger sliding rod to move towards the leg side plate along the strip hole, the trigger sliding rod is separated from the overhead hook on the upper end of the tibia connecting rod, while the two elastic energy storage elements contract and drive the tibia connecting rod to rotate away from the two thigh connecting rods until the two elastic energy storage elements completely reset.

6. The bionic jumping and flying robot based on a jumping-flapping wing composite structure according to claim 1, wherein the counterbeat flight module comprises a flight frame, a reduction gear set, two swing arms, two swing arm bases and two flapping wing units, the flight frame is connected to the driving body, the two flapping wing units are symmetrically installed on the flight frame, the reduction gear set is installed on the flight frame, an input end of the reduction gear set is connected to a second output end of the driving body, the two swing arm bases are installed on the flight frame through a shaft, the two swing arms, the two flapping wing units and the two swing arm bases are in one-to-one correspondence, one end of each of the two swing arms is hinged to a corresponding one of the two swing arm bases, each of the swing arm bases is connected to a corresponding one of the two flapping wing units, and an other end of each of the two swing arms is hinged to a corresponding one of two output ends of the reduction gear set.

7. The bionic jumping and flying robot based on a jumping-flapping wing composite structure according to claim 6, wherein the reduction gear set comprises a primary double-layer reduction gear and two secondary reduction gears, the primary double-layer reduction gear comprises a primary large gear and a primary small gear, a periphery of the primary large gear is engaged with an output small gear of the driving body, the primary small gear is coaxially connected onto one side of the primary large gear, a periphery of the primary small gear is engaged with the two secondary reduction gears, the two secondary reduction gears are in one-to-one correspondence with the two swing arms, and the other end of each of the two swing arms is eccentrically hinged to one side of a corresponding one of the two secondary reduction gear.

8. The bionic jumping and flying robot based on a jumping-flapping wing composite structure according to claim 6, wherein each of the two flapping wing units comprises a flapping wing skeleton and a flapping wing membrane, a root of the flapping wing skeleton is inserted into a corresponding one of the two swing arm bases, and a front end of the flapping wing membrane is pasted onto the flapping wing skeleton.

9. The bionic jumping and flying robot based on a jumping-flapping wing composite structure according to claim 1, wherein the driving body comprises a flight driving motor, a rear-end limit frame, fuselage side plates, a jumping driving motor, a front-end limit frame, a worm and a worm wheel, a groove is formed in the front-end limit frame, the flight frame of the counterbeat flight module is installed in the groove, the fuselage side plates are connected to leg side plates of the leg-foot type jumping module, the rear-end limit frame is located between the fuselage side plates and inserted in installation holes of the fuselage side plates, the flight driving motor is installed on the flight frame, the flight driving motor is connected with an output small gear configured for connecting an input end of the counterbeat flight module, the jumping driving motor is installed between the front-end limit frame and the rear-end limit frame, the jumping driving motor is connected to the worm, the worm is matched and connected with the worm wheel, and the worm wheel is connected to the D-shaped shaft of the leg-foot type jumping module.

10. The bionic jumping and flying robot based on a jumping-flapping wing composite structure according to claim 1, wherein the tail wing module comprises a tail wing base, a tail wing skeleton and a tail wing membrane, the tail wing base is installed on the fuselage side plates of the driving body, a root of the tail wing skeleton is inserted into the tail wing base, and the tail wing membrane is pasted onto the tail wing skeleton.
